(19) United States
(12) Patent Application Publication
(10) Pub. No.: US 2019/0277082 A1
(43) Pub. Date: Sep. 12, 2019

(54) PANELS

(71) Applicant: Simon MILLARD, Sutton Coldfield (GB)

(72) Inventor: Simon MILLARD, Sutton Coldfield (GB)

(21) Appl. No.: 16/348,868

(22) PCT Filed: Nov. 10, 2017
(86) PCT No.: PCT/GB2017/053398

§ 371 Date: May 9, 2019

(30) Foreign Application Priority Data
Nov. 10, 2016 (GB) 1619019.1
Jul. 6, 2017 (GB) 1710908.3

(51) Int. Cl. E06B 3/70; B32B 37/18; B32B 5/18; E06B 5/16; B32B 37/06

(52) U.S. Cl. CPC E06B 3/7015; B32B 37/18; B29L 2031/10; E06B 5/16; B32B 37/06; B32B 5/18

(57) ABSTRACT

A composite panel, for example formed as door (10), comprising a first fascia (11) and a second fascia (15) at least one of which is formed from metal structural sheet material, located between the first and second fascia (11,15) are a first structural foam layer (12), a metal core layer (13) and a second structural foam layer (14), the metal core layer (13) being as thin or thinner than the first fascia (11) and/or as thick or thicker than the second fascia (15).

This invention relates to composite panels in general and to doors made from said composite panels.

Traditionally doors have been made out of timber or plastics materials. Timber is a very robust material which is readily worked and formed but it is expensive and heavy, especially where a thick external door is required. Plastics materials (for example PVCu) are much cheaper but can be perceived to be flimsy in comparison.

Various other plastics materials have been proposed for the formation of doors, such as thermoset materials which tend to be more robust than thermoplastics like PVC but are usually more expensive.

There has been a need and desire to seek other materials for the formation of doors and aluminium has been proposed as a candidate. However, to date the uptake of aluminium doors has been slow in the UK market due to expense and issues with supply.

Accordingly, there is a need for a robust aluminium door which can be formed easily and from readily available materials. There is also a need for a door which is capable of providing a high degree of security. There is a need for a process which enables a manufacturer to form doors of various sizes and configurations quickly and easily.

Panels have been used to provide all sorts of cladding materials, building materials (roof, ceilings, floors, walls for example), decorative materials and separating structures and so on.

Accordingly, it is an object of this invention to provide a composite panel which can satisfy current and future demands.

A first aspect of the invention provides a composite panel comprising a first fascia and a second fascia at least one of which, and preferably both are formed from metal structural sheet material, located between the first and second fascia are a first structural foam layer, a metal core layer and a second structural foam layer, the core layer being as thin or thinner than the first fascia and/or as thick or thicker than the second fascia.

In this specification “structural sheet material” means that a sheet material which is sufficiently rigid to be self-supporting and “structural foam” is a closed or open cell foam with a density in excess of 20 kg/m³ for example in excess of 30 kg/m³, 40 kg/m³, 50 kg/m³, 60 kg/m³, 70 kg/m³ or 80 kg/m³ and preferably less than 1000 kg/m³ for example less than 900 kg/m³, 800 kg/m³, 700 kg/m³, 600 kg/m³, 500 kg/m³ or 400 kg/m³.

Preferably the first facia and/or the second fascia are formed from aluminium. The metal core layer may be formed from aluminium or steel or another suitable metal, for example, zinc. The first fascia, second fascia and/or the metal core may be a plain sheet or may be shaped, for example by cold rolling, knurling or embossing to provide local formations across all or a portion of the sheet material. In particular, the outermost surfaces may be provided with a surface decoration and/or may be shaped by a metal processing technique.

A suitable technique for forming the core layer and/or one or both of the first and second fascia may be provided by EP2091674.

In an embodiment the first fascia is from 0.5 to 50 mm thick, for example from 0.5 to 45 mm thick, 0.5 to 40 mm thick, 0.5 to 35 mm thick, 0.5 to 30 mm thick, 0.5 to 25 mm thick or 0.5 to 20 mm thick, 0.5 to 15 mm thick, 0.5 to 10 mm thick, 0.5 to 5 mm thick and may be from 0.5 to 4 mm thick, the second fascia is from 0.5 to 50 mm thick, for example from 0.5 to 40 mm thick, 0.5 to 30 mm thick, 0.5 to 20 mm thick, 0.5 to 10 mm thick, 0.5 to 5 mm thick or 0.5 to 4 mm thick. Preferably the first fascia is as thick or thicker than the second fascia. Preferably the first fascia, where the composite panel is configured to provide an external, fire or security door or panel, is configured to provide the external or secure fascia. In embodiments, the first and/or second structural foam layer may be formed of or may comprise a fire resistant or fire retardant foam material.

The core layer may extend across the entirety or some of the composite panel. Alternatively the core layer may extend across a major portion or a minor portion of the composite panel. For example, in a direction measured parallel to the principal plane of the core layer, the Core layer may extend across less than 50%, 50% or more than 50% of the composite panel, for example across 100% of the composite panel. In embodiments the core layer may be located at each of the transverse peripheral edges of the composite panel and each may extend inwardly by up to 10% of the width of the composite panel, for example up to 15%, 20%, 25%, 30%, 35%, 40%, 45%, 50%. If both extend by 50% across the panel the core layer may be conveniently provided as a unitary layer.

Each of the structural foam layers may be formed from polyethylene terephthalate, polyurethane, acrylonitrile-butadiene-styrene (ABS), polystyrene (PS), polycarbonate (PC), polypropylene (PP) or polyvinyl chloride (PVC) and mixtures of the same.

In embodiments the first structural foam layer is thicker, the same thickness or thinner than the second structural foam layer.

In embodiments the density of the first structural foam layer is greater, the same or smaller than that of the second structural foam layer.

Preferably the first structural foam layer, where the composite panel is configured to provide an external, fire or security door or panel, is configured to be located towards the external surface of the door or panel.

The panel may have a first peripheral edge for mounting of hinges.

One or both of the first structural foam layer or the second structural foam layer may comprise inserts for the retention of fixing means, such as screws. The inserts may be located at the peripheral edge. The inserts may be formed of or may comprise metal, for example aluminium, or plastic, carbon fibre or fibre glass.

The peripheral edge may comprise one or more foam inserts. The foam inserts may extend along the peripheral edge, at least in the region where hinges are required. The foam inserts may have a density higher than that of the either the first or second structural foam layers.

The composite panel may comprise a trim extending over the panel, for example over one, two, three or all of the peripheral edges of the panel. The trim may comprise a plain section adhered to the peripheral edge. Alternatively, the trim may comprise a U-section, wherein the legs of the U-section embrace the terminal portions of the first and/or second fascias in the region of the peripheral edge. Alternatively, the trim may comprise a L-section or a Z-section. The trim may comprise an extension portion, extending within the first structural foam layer or the second structural foam layer or between the first structural foam layer and the second structural foam layer. The core layer may extend from the trim.

The trim may be composed of carbon fibre, but may also be composed of an alternative material such as metal, for example aluminium or steel, or plastic or fibre glass. The trim may be or may comprise material which is fire retardant. The trim may be formed by one or more of cold rolling, hot rolling, moulding, extrusion or pultrusion.

The first fascia and/or the second fascia and/or trim may be provided with a decorative or functional coating. The first fascia and/or the second fascia and/or trim may be embossed, painted, powder coated, covered or otherwise finished to provide a desired surface.

A further aspect of the invention provides a composite panel comprising a first fascia and a second fascia preferably each formed from metal structural sheet material, located between the first and second fascia are a first structural foam layer, a metal core layer and a second structural foam layer, the first structural foam layer being thinner and/or having a higher density than the second structural foam layer.

A further aspect of the invention provides a composite panel comprising a first fascia preferably formed from metal structural sheet material, a second fascia preferably formed from a structural sheet material, located between the first and second fascia is a structural foam layer, the structural foam layer comprising inserts for the retention of fixing means, such as screws. Preferably the structural foam layer is secured to the first and/or second fascia by fusion bonding.

The second fascia may be composed of a metal, for example aluminium or steel, or glass, fibre glass, wood, rubber, cork, plastic, carbon fibre or another composite material.

A yet further aspect of the invention provides a method of forming a composite panel or door, the method comprising the steps of:
a) Heating a first structural sheet member and bringing it into intimate contact with a first structural foam layer whereby a first surface of the foam layer is melted to secure the first structural sheet member to the first structural foam layer;
b) Providing a second structural sheet member and bringing that into intimate contact with the first structural foam layer to secure a second surface of the foam layer to the second structural sheet member;
c) Heating a third structural sheet member and bringing it into intimate contact with a second structural foam layer whereby a first surface of the second structural foam layer is melted to secure the third structural sheet member to the second structural foam layer;
d) Securing the second structural sheet member to the second structural foam layer.

In steps b) and d) the securing may be achieved using an adhesive and/or by heating the second structural sheet member.

A more particular aspect of the invention provides a method of forming a composite panel or door, the method comprising the steps of:
a) Heating a or the first structural sheet member and bringing it into intimate contact with a or the first structural foam layer whereby a first surface of the foam layer is melted to secure the first structural sheet member to the first structural foam layer;
b) Heating a or the second structural sheet member and bringing that into intimate contact with the first structural foam layer whereby a or the second surface of the foam layer is melted to secure the second structural sheet member to the first structural foam layer;
c) Heating a or the third structural sheet member and bringing it into intimate contact with a or the second structural foam layer whereby a or the first surface of the second structural foam layer is melted to secure the third structural sheet member to the second structural foam layer;
d) Heating the second structural sheet member and bringing it into intimate contact with the second structural foam layer whereby a second surface of the second structural foam layer is melted to secure the second structural sheet member to the second structural foam layer.

The steps a) to d) may be completed in series or in any order.

Further layers of structural foam and/or structural sheet member may be provided to provide a thicker composite panel. The composite panel may be shaped to form a door, a door frame, a window frame, a structural frame.

The composite panel may also be used as a door. Additionally the composite panel may be employed as a construction material. The composite panel may be used, for example, as flooring, ceilings and/or external and/or internal walls in building construction. The composite panel may be used as, or as a component of, external cladding for use in building construction and/or insulation. The composite panel may be used as a construction material in the manufacture of aircraft, trains and/or other vehicles.

The composite panel may be used as a construction material with fire resistant or fire retardant properties. For example, as a fire door, or fire resistant or fire retardant external cladding, by selecting a structural foam that is fire resistant or fire retardant for use in manufacturing the composite panel.

The structural sheet member need not extend across the entirety of the facing structural foam layer.

In each embodiment, the composite panel may be provided with a first or second fascia which is formed of a metal structural sheet material and the other of the second or first fascia comprises, or is provided with a covering of, a non-structural and/or decorative material. The non-structural and/or decorative material may be formed of plastics, composites, ceramics, carbon fibre, fibre-glass, timber, cork, hard or soft wood, laminates, cloth, textile, rubber.

Inserts may be located within one, both, some or all of the structural foam layers. The inserts may be located by fusion bonding, adhesive or in situ foaming, or other methods known to the skilled addressee.

In order that the invention may be more fully understood, it will now be described, by way of example only, and with reference to the accompanying drawings, in which:

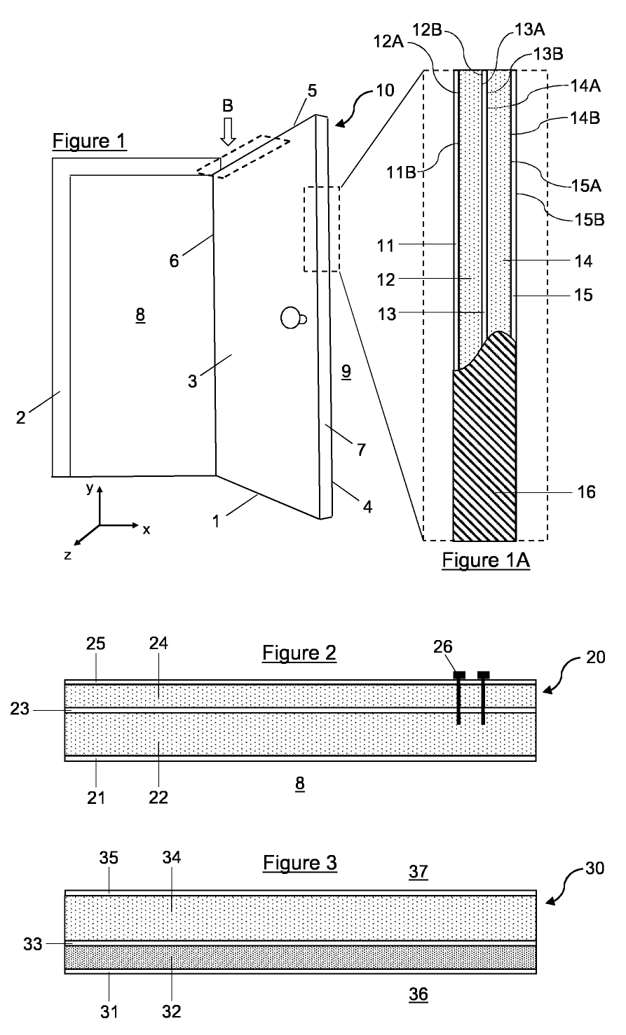

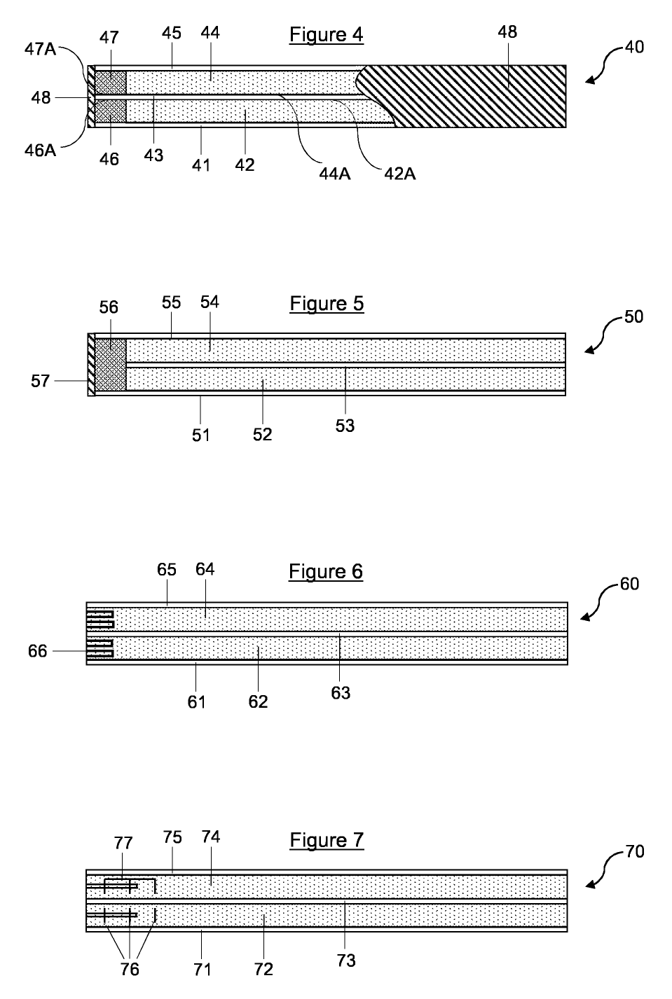

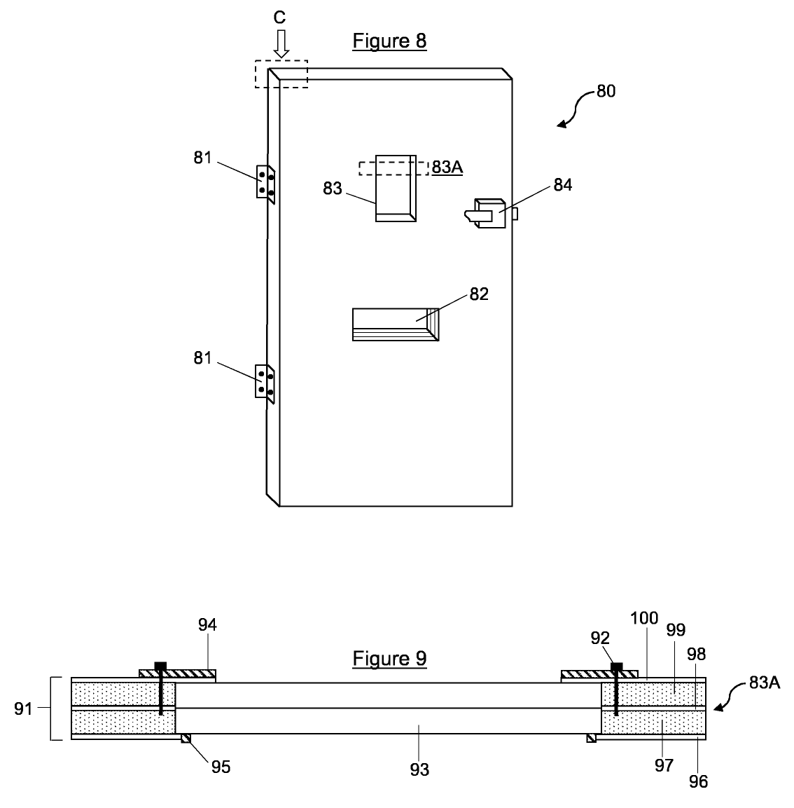

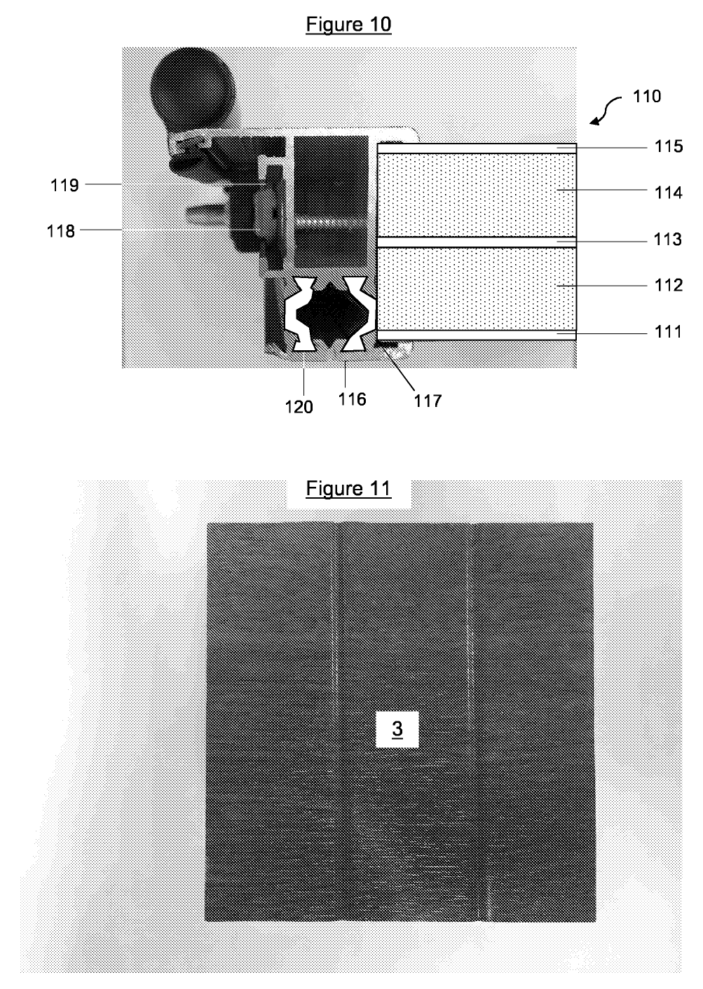

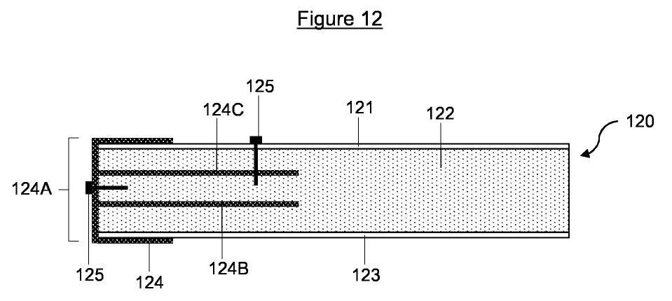

FIG. 1 is an elevation of a door according to the invention

FIG. 1A is an enlarged view of a portion of the door of FIG. 1

FIG. 2 is an enlarged view of a second embodiment of a portion of the door of FIG. 1

FIG. 3 is an enlarged view of a third embodiment of a portion of the door of FIG. 1;

FIG. 4 is an enlarged view of a portion of the door of FIG. 1;

FIG. 5 is an enlarged view of a further embodiment of a portion of the door of FIG. 1;

FIG. 6 is an enlarged view of a further embodiment of a portion of the door of FIG. 1;

FIG. 7 is an enlarged view of a further embodiment of a portion of the door of FIG. 1;

FIG. 8 is an elevation of a machined door according to the invention;

FIG. 9 is a sectional view of a window fitted within the door of FIG. 8;

FIG. 10 is an enlarged view of a second embodiment of the door of FIG. 8;

FIG. 11 is a plan view of a surface finished portion of a door according to the invention; and

FIG. 12 is an enlarged view of a further embodiment of a portion of the door of FIG. 8.

Referring first to FIG. 1 there is shown a door 10 according to the invention. The door 10 may be an external door fitted with hinges (not shown) hung to a door frame 2. The door 10 has an outer surface 3, an inner surface 4, a top peripheral edge 5, an inner peripheral edge 6 and an outer peripheral edge 7. If the door 10 is to be hung as an external door the outer surface 3 will face the external environment 8 whilst the internal surface 4 will face the internal environment 9.

Referring now to FIG. 1A there is shown an enlarged view of a portion of the door 10 showing a part of the outer peripheral edge 7 of door 10. The door 10 has a sandwich structure comprising a first outer fascia 11, a first structural foam layer 12, a core layer 13, a second structural foam layer 14, and a second outer fascia 15. The first outer fascia 11 forms (or is adjacent) the outer surface 3 of the door 10, which may face the external environment 8. The opposite surface 11B of the first outer fascia 11 is secured to a major surface 12A of the first structural foam layer 12, an opposite surface 12B of which is secured to a first major surface 13A of the core layer 13. The core layer 13 forms a layer at or towards the centre of the door 10. The core layer 13 is sandwiched between the first structural foam layer 12 and the second structural foam layer 14. A second major surface 13B of the core layer 13 is secured to a first major surface 14A of the second structural foam layer 14, an opposite surface 14B of which is secured to a first major surface 15A of second outer fascia 15. A second major surface 15B of the outer fascia 15 forms (or lies adjacent) the inner surface 4 of the door 10, which faces the internal environment 9 of a building. The door 10 may be capped with a trim 16, which is secured to the exposed terminal edges of layers 11 to 15 around the entire periphery of the door 10, that is, along the outer peripheral edge 7 in addition to the top peripheral edge 5 and preferably the inner peripheral edge 6 and bottom edge 1 of the door 10. For clarity, only a portion of the trim 16 is shown in FIG. 1A and the remainder has been omitted to reveal the layers 11 to 15 of door 10. In this embodiment, the layered structure described is uniform throughout the door 10 at every cross section.

Preferably, the first outer fascia 11, the second outer fascia 15, and the core layer 13 are composed of metal. More preferably, the first outer fascia 11, the second outer fascia 15, and the core layer 13 are composed of aluminium. Preferably, the first structural foam layer 12 and the second structural foam layer 14 are composed of a closed cell thermoplastic polymer foam. More preferably, first structural foam layer 12 and the second structural foam layer 14 are composed of closed cell polyethylene terephthalate (PET) polymer foam.

We have found that a door formed in accordance with FIG. 1A and having the following characteristics was eminently suitable for use as an exterior door 10:

| | | Dimensions of Each | | |
|---|---|---|---|---|
| | | Layer (mm) | | |
| Example | Layer | Height | Width | Depth |
| 1a | First outer fascia 11 | 1981 | 762 | 2 |
| | First structural foam layer 12 | 1981 | 762 | 15 |
| | Core layer 13 | 1981 | 762 | 2 |
| | Second structural foam layer 14 | 1981 | 762 | 15 |
| | Second outer fascia 15 | 1981 | 762 | 1 |
| | Dimensions of Door 10 (mm) | 1981 | 762 | 35 |
| 1b | First outer fascia 11 | 1981 | 838 | 3 |
| | First structural foam layer 12 | 1981 | 838 | 17 |
| | Core layer 13 | 1981 | 838 | 2 |
| | Second structural foam layer 14 | 1981 | 838 | 17 |
| | Second outer fascia 15 | 1981 | 838 | 1 |
| | Dimensions of Door 10 (mm) | 1981 | 838 | 40 |
| 1c | First outer fascia 11 | 2032 | 813 | 4 |
| | First structural foam layer 12 | 2032 | 813 | 20 |
| | Core layer 13 | 2032 | 813 | 2 |
| | Second structural foam layer 14 | 2032 | 813 | 20 |
| | Second outer fascia 15 | 2032 | 813 | 1 |
| | Dimensions of Door 10 (mm) | 2032 | 813 | 47 |

| | | Specification of Structural Foam Layers 12 and 14 | | | | |
|---|---|---|---|---|---|---|
| | Structural | in Examples 1a-1c | | | | |
| | Foam | | Density | *CS | *TS | *SS |
| Example | Layer | Material | (kg/m³) | (N/mm²) | (N/mm²) | (N/mm²) |
| 1a | 12 | PET | 93-107 | 1.4 | 2.0 | 0.8 |
| | 14 | PET | 93-107 | 1.4 | 2.0 | 0.8 |
| 1b | 12 | PET | 93-107 | 1.4 | 2.0 | 0.8 |
| | 14 | PET | 93-107 | 1.4 | 2.0 | 0.8 |
| 1c | 12 | PET | 103-117 | 1.6 | 2.3 | 0.9 |
| | 14 | PET | 103-117 | 1.6 | 2.3 | 0.9 |

*CS = Compressive strength perpendicular to plane x; TS = Tensile strength perpendicular to plane x; SS = Sheer strength crosswise.

As shown in Examples 1a-1c, the structural foam layers 12 and 14 may be composed of a closed-cell thermoplastic foam, such as polyethylene terephthalate (PET), with a density of, for example, say between 90 kg/m³ and 120 kg/m³. The structural foam layers 12 and 14 within door 10 provide a lightweight structure whilst also possessing high mechanical properties. For example, the structural foam layers of Examples 1a-1c possess a compressive strength perpendicular to plane x of the door 10 of between 1.4 N/mm² and 1.6 N/mm², a tensile strength perpendicular to plane x of the door 10 of between 2.0 N/mm² and 2.3 N/mm², and a sheer strength crosswise of between 0.8 N/mm² and 0.9 N/mm².

Advantageously, the load bearing capacity of the structural foam layers 12 and 14 allows the door 10 to be directly mounted to a door frame 2 using hinges, by screwing directly into the structural foam layers 12 and 14. Advantageously, the structural foam layers 12 and 14 are fatigue resistant, chemically stabile, and have negligible water absorption. These advantageous properties provide a door 10, which is resistant to the weather elements as well as cleaning products.

We have found that the presence of the core layer 13 confers additional strength and stability to the door 10, which provides greater resistance to warping or bending. Advantageously, the strength of the layered structure of the door 10 allows a thinner layer of metal to be used for the second outer fascia 15, in comparison to the first outer fascia 11, which reduces the weight of the door and the cost.

The rigidity and added physical resilience afforded to the door 1 by the presence of the core layer 13 is also beneficial. The core layer 13 is as thick or thicker than the second outer fascia 15 and as thin or thinner than the first outer fascia 11.

Referring now to FIG. 2 there is shown an enlarged view of a second embodiment of the door 20 of FIG. 1. The door 20 comprises the following layers, which are secured successively in a sandwich structure in the following order: (i) first outer fascia 21; (ii) first structural foam layer 22; (iii) core layer 23; (iv) second structural foam layer 24; and (v) second outer fascia 25. In this embodiment, the first outer fascia 21 forms the outer surface 3 of the door 20, and the second outer fascia 25 forms the inner surface 4 of the door 20.

We have found that a door formed in accordance with FIG. 2 and having the following characteristics was eminently suitable for use as an external or internal door:

| | | Dimensions of Each | | |
|---|---|---|---|---|
| | | Layer (mm) | | |
| Example | Layer | Height | Width | Depth |
| 2a | First outer fascia 21 | 1981 | 762 | 2 |
| | First structural foam layer 22 | 1981 | 762 | 20 |
| | Core layer 23 | 1981 | 762 | 2 |
| | Second structural foam layer 24 | 1981 | 762 | 10 |
| | Second outer fascia 25 | 1981 | 762 | 1 |
| | Dimensions of Door 20 (mm) | 1981 | 762 | 35 |
| 2b | First outer fascia 21 | 1981 | 838 | 2 |
| | First structural foam layer 22 | 1981 | 838 | 25 |
| | Core layer 23 | 1981 | 838 | 2 |
| | Second structural foam layer 24 | 1981 | 838 | 5 |
| | Second outer fascia 25 | 1981 | 838 | 1 |
| | Dimensions of Door 20 (mm) | 1981 | 838 | 35 |
| 2c | First outer fascia 21 | 2032 | 813 | 4 |
| | First structural foam layer 22 | 2032 | 813 | 28 |
| | Core layer 23 | 2032 | 813 | 2 |
| | Second structural foam layer 24 | 2032 | 813 | 10 |
| | Second outer fascia 25 | 2032 | 813 | 1 |
| | Dimensions of Door 20 (mm) | 2032 | 813 | 45 |
| 2d | First outer fascia 21 | 1981 | 838 | 2 |
| | First structural foam layer 22 | 1981 | 838 | 25 |
| | Core layer 23 | 1981 | 838 | 2 |
| | Second structural foam layer 24 | 1981 | 838 | 5 |
| | Second outer fascia 25 | 1981 | 838 | 1 |
| | Dimensions of Door 20 (mm) | 1981 | 838 | 35 |

| | | Specification of Structural Foam Layers 22 and 24 | | | | |
|---|---|---|---|---|---|---|
| | Structural | in Examples 2a-2d | | | | |
| | Foam | | Density | *CS | *TS | *SS |
| Example | Layer | Material | (kg/m³) | (N/mm²) | (N/mm²) | (N/mm²) |
| 2a | 22 | PET | 103-117 | 1.6 | 2.3 | 0.9 |
| | 24 | PET | 103-117 | 1.6 | 2.3 | 0.9 |
| 2b | 22 | PET | 93-107 | 1.4 | 2.0 | 0.8 |
| | 24 | PET | 93-107 | 1.4 | 2.0 | 0.8 |
| 2c | 22 | PET | 93-107 | 1.4 | 2.0 | 0.8 |
| | 24 | PET | 93-107 | 1.4 | 2.0 | 0.8 |
| 2d | 22 | PET | 93-107 | 1.4 | 2.0 | 0.8 |
| | 24 | PET | 103-117 | 1.6 | 2.3 | 0.9 |

*CS = Compressive strength perpendicular to plane x; TS = Tensile strength perpendicular to plane x; SS = Sheer strength crosswise.

As shown in Examples 2a-2d, the structural foam layers 22 and 24 have an identical specification to those disclosed in Examples 1a-1c, differing only in their dimensions. The first structural foam layer 22 has a greater depth compared to the second structural foam layer 24, within the door 20. Advantageously, this confers additional heat insulating capabilities on the door 20, especially in the case that the first outer surface 21 surfaces an external environment 8 with a temperature lower than that of the internal environment (or vice versa).

Advantageously, this also provides a facile method of manufacturing doors of different depths or thicknesses, which may be required depending on the frame size provided.

Advantageously, the higher density foam of the second structural foam layer 24 may act as a reinforced attachment point for hinges and door furniture. More advantageously, the use of a thinner second structural foam layer 24 with high mechanical properties provides the ability to affix screws directly through the second outer fascia 23, which faces the internal environment 9, the second structural foam layer 24 and the core layer 23. This provides a greatly reinforced attachment point, which traverses three layers of the composite door 20, and also reduces the quantity of relatively expensive and heavy high density foam that is used for first structural foam layer 22.

Referring now to FIG. 3 there is shown an enlarged view of a third embodiment of a portion of the door 30 of FIG. 1. The door 30 comprises the following layers, which are secured successively in a sandwich structure in the following order: (i) first outer fascia 31; (ii) first structural foam layer 32; (iii) core layer 33; (iv) second structural foam layer 34; and (v) second outer fascia 35. In this embodiment, the density of the first structural foam layer 32 is higher than that of the second structural foam layer 34.

We have found that a door 30 formed in accordance with FIG. 3 and having the following characteristics was eminently suitable for use as a fire door:

| | | Dimensions of Each | | |
|---|---|---|---|---|
| | | Layer (mm) | | |
| Example | Layer | Height | Width | Depth |
| 3a | First outer fascia 31 | 1981 | 762 | 2 |
| | First structural foam layer 32 | 1981 | 762 | 20 |
| | Core layer 33 | 1981 | 762 | 2 |
| | Second structural foam layer 34 | 1981 | 762 | 20 |
| | Second outer fascia 35 | 1981 | 762 | 1 |
| | Dimensions of Door 30 (mm) | 1981 | 762 | 45 |
| 3b | First outer fascia 31 | 1981 | 838 | 2 |
| | First structural foam layer 32 | 1981 | 838 | 15 |
| | Core layer 33 | 1981 | 838 | 3 |
| | Second structural foam layer 34 | 1981 | 838 | 24 |
| | Second outer fascia 35 | 1981 | 838 | 1 |
| | Dimensions of Door 30 (mm) | 1981 | 838 | 45 |
| 3c | First outer fascia 31 | 2040 | 726 | 4 |
| | First structural foam layer 32 | 2040 | 726 | 10 |
| | Core layer 33 | 2040 | 726 | 2 |
| | Second structural foam layer 34 | 2040 | 726 | 28 |
| | Second outer fascia 35 | 2040 | 726 | 1 |
| | Dimensions of Door 30 (mm) | 2040 | 726 | 45 |

| | | Specification of Structural Foam Layers 32 and 34 | | | | |
|---|---|---|---|---|---|---|
| | Structural | in Examples 3a-3c | | | | |
| | Foam | | Density | *CS | *TS | *SS |
| Example | Layer | Material | (kg/m³) | (N/mm²) | (N/mm²) | (N/mm²) |
| 3a | 32 | PET | 105-115 | 1.4 | 2.2 | 0.8 |
| | 34 | PET | 93-107 | 1.4 | 2.0 | 0.8 |
| 3b | 32 | PET | 140-150 | 2.2 | 2.7 | 1.2 |
| | 34 | PET | 103-117 | 1.6 | 2.3 | 0.9 |
| 3c | 32 | PET | 200-220 | 3.5 | 3.0 | 1.85 |
| | 34 | PET | 93-107 | 1.4 | 2.0 | 0.8 |

*CS = Compressive strength perpendicular to plane x; TS = Tensile strength perpendicular to plane x; SS = Sheer strength crosswise.

As shown in Examples 3a-3c, the first structural foam layer 32 may be composed of a closed-cell thermoplastic foam, such as polyethylene terephthalate, with a density of, for example, say between 100 kg/m³ and 220 kg/m³. Additionally, the structural foam layer 32 possesses high mechanical properties, such as having a compressive strength perpendicular to plane x of the door 30 of between 1.4 N/mm² and 3.5 N/mm², a tensile strength perpendicular to plane x of the door 30 of between 1.5 N/mm² and 3.0 N/mm², and a sheer strength crosswise of between 0.8 N/mm² and 1.85 N/mm².

The second structural foam layer 34 may be composed of a closed-cell thermoplastic foam, such as polyethylene terephthalate, with a density of, for example, say between 93 kg/m³ and 117 kg/m³, a compressive strength perpendicular to plane x of the door 30 of between 1.4 N/mm² and 1.6 N/mm², a tensile strength perpendicular to plane x of the door 30 of between 2.0 N/mm² and 2.3 N/mm², and a sheer strength crosswise of between 0.8 N/mm² and 0.9 N/mm².

Alternatively, the Examples 3a-3c of door 30 may be used for the purpose of a fire door, which is intended to prevent fire spreading through a building. In this case, at least one of the structural foam layers 32 or 34 is selected to comprise a fire resistant or fire retardant component. Advantageously, only one structural foam layer, for example, the first structural foam layer 32, may have the fire resistant or fire retardant component. An example of a fire retardant structural foam is Airex® T90® available from Airex AG of Switzerland. This type of foam has superior fire retardance, and excellent fire, smoke and toxicity (FST) properties. However, other suitable fire retardant foams may also be used for manufacture of a suitable fire door such as those described in Examples 3a-3c.

Using Example 3c as an example fire door, the first outer fascia 31 faces the environment at high risk of fire 36, in which fire and smoke need to be contained. The second outer fascia 35 faces the low risk environment 37 that needs to be protected from fire and smoke. Advantageously, the use of a fire retardant structural foam layer 32 in door 30 provides a fire door, preferably a thin and lightweight fire door with excellent fire and smoke resistance properties. The first structural foam layer 32 is fire retardant and is of a higher density compared to the second structural foam layer 34. The second structural foam layer 34 need not have a fire-retardant component. The first structural foam layer 32 may also be thinner in comparison to the second structural foam layer 34, which greatly reduces the quantity and cost of the fire-retardant foam required to manufacture the door 30 of Example 3c.

The composite doors in all embodiments described may be manufactured using a fusion bonding process in the absence of adhesives. By fusion bonding we mean heating a metal sheet to an elevated temperature and typically a temperature sufficient to melt a surface layer of the structural foam when the two are in close proximity, for example 260° C., then bringing the metal sheet into contact with the structural foam and adding pressure to bond the two surfaces, the melted surface layer of structural foam acting as the bonding agent to the metal sheet, and subsequently cooling the metal to produce the fusion bonded article.

Advantageously, this process does not require adhesives, which can take up to 24 hours to cure. The structural foam described benefits from being thermally stable to high temperature during processing and post curing. Therefore, this process is both cost and time effective for the manufacture of lightweight composite doors with advantageous features such as fire retardance and enhanced load bearing capabilities.

In a method of manufacturing a composite panel for use as a door, a door frame or a window frame, using door 10 in FIG. 1 as an example, the method may comprise steps of: (a) Securing the first major surface 13A of a core layer 13 to the first major surface 12B of a first structural foam layer 12; (b) Securing the second major surface 13B of the core layer 13 to the first major surface 14A of a second structural foam layer 14; (c) Securing a major surface 11B of first outer fascia 11 to the second major surface 12A of the first structural foam layer 12; and (d) Securing a major surface 15A of second metal fascia 15 to a second major surface 14B of the second structural foam layer 14 to result in the finished composite panel for use in door 10.

Additionally or alternatively, the composite doors in all embodiments 10, 20, and 30 described above may be manufactured by using adhesives, which may be used to adhere each layer in the composite door 10, 20, and 30.

The door 10 of FIG. 1, may have a consistent and identical cross sectional structure running throughout and across the door 10. Alternatively, and referring now to FIG. 4 where there is shown an enlarged view of the door 40 similar to the door 10 of FIG. 1 and viewed in the direction of arrow B, a portion of the top peripheral edge 5 of door 40 is shown. The door 40 comprises the following layers, which are secured successively in a sandwich structure in the following order: (i) first outer fascia 41; (ii) first structural foam layer 42; (iii) core layer 43; (iv) second structural foam layer 44; and (v) second outer fascia 45. In this example, there is a first structural foam insert 46 and a second structural foam insert 47, which abut the structural foam layers 42 and 44 respectively, and are separated by the core layer 43. The first and second structural foam inserts 46 and 47 are provided along the entire inner peripheral edge 6 of door 40.

The door 40 may be capped with a trim 48, which is secured to the exposed terminal edges of layers 41 to 45, and first and second structural foam inserts 46 and 47, along the top peripheral edge 5 and the inner peripheral edge 6, in addition to the outer peripheral edge 7 of the door 40. For clarity, only a portion of the trim 48 is shown in FIG. 4 and the remainder has been omitted to reveal the layers 41 to 45 along the top peripheral edge 5 of door 40.

The first and second structural foam inserts 46 and 47 are composed of a higher density foam in comparison to the structural foam layers 42 and 44. Therefore, the higher density structural foam inserts 46 and 47 have high mechanical properties. Advantageously, this provides a door 40 with a reinforced area along the inner peripheral edge 6 for hanging to the door frame 2. This means that a lower density and therefore cheaper structural foam can be used in structural foam layers 42 and 44, making the door 40 lightweight and also is also less expensive to manufacture.

During the manufacture of the type of door 40 shown in FIG. 4, the first structural foam insert 46 may be placed adjacent to the first structural foam layer 42 to form a continuous foam layer of equal depth. The first outer fascia 41 is secured to the resulting continuous foam layer comprised of both the first structural foam insert 46 and the first structural foam layer 42, in a fusion bonding process, or by using adhesives. This process is repeated, instead using the second structural foam insert 47 and the second structural foam layer 44, which are secured to the second outer fascia 45. The exposed major surfaces 42A, 44A, 46A and 47A of the structural foam layers 42 and 44, and structural foam inserts 46, 47 of each of the resulting components are then secured to the core layer 43, so that the core layer 43 is sandwiched between the exposed major surfaces 42A, 44A, 46A and 47A of the structural foam layers 42 and 44 and the structural foam inserts 46 and 47.

Alternatively, the first and second structural foam inserts 46 and 47 may also be secured within door 40 by taking a composite panel of any embodiment of door 40 described above, removing a corresponding portion of the first structural foam layer 42 by machining using a router or by any other means, and removing a corresponding portion of the second structural foam layer 44 using the same method. The first structural foam insert 46 may then be inserted into the vacant gap between the first outer fascia 41 and the core layer 43. The second structural foam insert 47 may then be inserted into the vacant gap between the second outer fascia 45 and the core layer 43, and secured using adhesive or in a fusion bonding process.

The trim 48 is secured to the top peripheral edge 5, inner peripheral edge 6, and outer peripheral edge 7 of door 40 using adhesive or other methods of attachment. The trim 48 may be composed of carbon fibre, but may also be composed of an alternative material such as metal, for example aluminium, or plastic.

Referring now to FIG. 5 there is shown an enlarged view of another embodiment of a door 50 similar to that of FIG. 1, which shows a portion of the top peripheral edge 5 of door 50. The door 50 comprises the following layers, which are secured successively in a sandwich structure in the following order: (i) first outer fascia 51; (ii) first structural foam layer 52; (iii) core layer 53; (iv) second structural foam layer 54; and (v) second outer fascia 55. In this embodiment, there is one structural foam insert 56, which abuts the terminal edges of first structural foam layer 52, the core layer 53, and the second structural foam layer 54. The structural foam insert 56 is provided along the entire inner peripheral edge 6 of door 50.

The door 50 may be capped with a trim 57, which is secured to the exposed terminal edges of layers 51 to 55, and structural foam insert 56, along the top peripheral edge 5 and the inner peripheral edge 6, in addition to the outer peripheral edge 7 of the door 50. For clarity, trim 57 is shown on the inner peripheral edge 6 of door 50 of FIG. 5, but has been omitted from the top peripheral edge 5 for clarity. Advantageously, the addition of trim 48 in FIG. 4 and trim 57 in FIG. 5, which may be composed of carbon fibre, confers resistance to bowing or warping at the edges of the door 40 and 50.

We have surprisingly found that a door formed in accordance with FIGS. 4 and 5, and having the following characteristics was eminently suitable for use as a door with a reinforced area for anchoring screws:

| | | Dimensions of Each | | |
|---|---|---|---|---|
| | | Layer (mm) | | |
| Example | Layer | Height | Width | Depth |
| 4a | First outer fascia 41 | 1981 | 762 | 2 |
| | First structural foam layer 42 | 1981 | 612 | 20 |
| | First structural foam insert 46 | 1981 | 150 | 20 |
| | Core layer 43 | 1981 | 762 | 2 |
| | Second structural foam layer 44 | 1981 | 612 | 20 |
| | Second structural foam insert 47 | 1981 | 150 | 20 |
| | Second outer fascia 45 | 1981 | 762 | 1 |
| | Dimensions of Door 40 (mm) | 1981 | 762 | 45 |
| 4b | First outer fascia 41 | 1981 | 838 | 2 |
| | First structural foam layer 42 | 1981 | 738 | 10 |
| | First structural foam insert 46 | 1981 | 100 | 10 |
| | Core layer 43 | 1981 | 838 | 2 |
| | Second structural foam layer 44 | 1981 | 738 | 20 |
| | Second structural foam insert 47 | 1981 | 100 | 20 |
| | Second outer fascia 45 | 1981 | 838 | 1 |
| | Dimensions of Door 40 (mm) | 1981 | 838 | 35 |
| 4c | First outer fascia 41 | 2040 | 726 | 3 |
| | First structural foam layer 42 | 2040 | 646 | 20 |
| | First structural foam insert 46 | 2040 | 80 | 20 |
| | Core layer 43 | 2040 | 726 | 2 |
| | Second structural foam layer 44 | 2040 | 646 | 10 |
| | Second structural foam insert 47 | 2040 | 80 | 10 |
| | Second outer fascia 45 | 2040 | 726 | 1 |
| | Dimensions of Door 40 (mm) | 2040 | 726 | 36 |
| 5a | First outer fascia 51 | 2040 | 726 | 2 |
| | First structural foam layer 52 | 2040 | 626 | 20 |
| | Single structural foam insert 56 | 2040 | 100 | 42 |
| | Core layer 53 | 2040 | 626 | 2 |
| | Second structural foam layer 54 | 2040 | 626 | 20 |
| | Second outer fascia 55 | 2040 | 726 | 1 |
| | Dimensions of Door 50 (mm) | 2040 | 726 | 45 |

| | | Specification of Structural Foam Layers and | | | | |
|---|---|---|---|---|---|---|
| | Structural | Inserts 42, 44, 46, 47 in Examples 4a-4c | | | | |
| | Foam | and 52, 54, 56 in Example 5a | | | | |
| | Layer | | Density | *CS | *TS | *SS |
| Example | or Insert | Material | (kg/m³) | (N/mm²) | (N/mm²) | (N/mm²) |
| 4a | 42 | PET | 93-107 | 1.4 | 2.0 | 0.8 |
| | 44 | PET | 93-107 | 1.4 | 2.0 | 0.8 |
| | 46 | PET | 127-143 | 2.4 | 2.6 | 1.3 |
| | 47 | PET | 127-143 | 2.4 | 2.6 | 1.3 |
| 4b | 42 | PET | 105-115 | 2.1 | 2.4 | 1.05 |
| | 44 | PET | 93-107 | 1.4 | 2.0 | 0.8 |
| | 46 | PET | 200-220 | 3.5 | 3.1 | 2.0 |
| | 47 | PET | 127-143 | 2.4 | 2.6 | 1.3 |
| 4c | 42 | PET | 93-107 | 1.4 | 2.0 | 0.8 |
| | 44 | PET | 103-117 | 1.6 | 2.3 | 0.9 |
| | 46 | PET | 127-143 | 2.4 | 2.6 | 1.3 |
| | 47 | PET | 310-330 | 7.1 | 4.5 | 3.5 |
| 5a | 52 | PET | 93-107 | 1.4 | 2.0 | 0.8 |
| | 54 | PET | 103-117 | 1.6 | 2.3 | 0.9 |
| | 56 | PET | 310-330 | 7.1 | 4.5 | 3.5 |

*CS = Compressive strength perpendicular to plane x; TS = Tensile strength perpendicular to plane x; SS = Sheer strength crosswise.

We have surprisingly found that the use of first and second structural foam inserts 46 and 47, and single structural foam insert 56, composed of a closed cell, thermoplastic polymer foam, such as polyethylene terephthalate, with a high density of, for example, say between 127 kg/m³ and 330 kg/m³, in accordance with Examples 4a-4c, and Example 5a in the above table, provide a reinforced area for attachment of screws and other door furniture, with high mechanical properties.

Advantageously, these features provide a reinforced inner peripheral edge 6, which increases the load bearing capabilities of the door 40 or 50 by providing a reinforced position for attachment of screws for hinges, used for mounting the door 40 or 50 to a door frame 2. This reinforced area is particularly advantageous for doors which will be opened and closed multiple times a day in buildings with heavy traffic.

Referring now to FIG. 6 there is shown an enlarged view of a further embodiment of a door 60 similar to that shown in FIG. 1, a portion in the direction of arrow B being shown. The door 60 comprises the following layers, which are secured successively in a sandwich structure in the following order: (i) first outer fascia 61; (ii) first structural foam layer 62; (iii) core layer 63; (iv) second structural foam layer 64; and (v) second outer fascia 65. In this embodiment, metal plugs 66 are embedded within the first structural foam layer 62 and the second structural foam layer 64. The metal plugs 66 can be embedded into the first and second structural foam layers 62 and 64 during the manufacturing process of the door 60, by drilling, machining or otherwise.

Referring now to FIG. 7 there is shown an enlarged view of a further embodiment of a door 70 according to FIG. 1, a portion in the direction of arrow B being shown. The door 70 comprises the following layers, which are secured successively in a sandwich structure in the following order: (i) first outer fascia 71; (ii) first structural foam layer 72; (iii) core layer 73; (iv) second structural foam layer 74; and (v) second outer fascia 75. In this embodiment, metal inserts 76 and extrusion inserts 77 are embedded within the first structural foam layer 72 and the second structural foam layer 74. The metal inserts 76 and extrusion inserts 77 are preferably embedded into the first and second structural foam layers 72 and 74 during the manufacturing process of the door 70, but may also be located by drilling, machining, or otherwise. The metal inserts 76 and extrusion inserts 77 may be inserted into the door 70 perpendicular to the plane of the door 70 or in parallel to the plane of the door 70.

Advantageously, the metal plugs 66, metal inserts 76 and extrusion inserts 77 provide a reinforced attachment point for inserting and securing screws within the structure of the door 70, for attachment of the door 70 to a frame 2 with a hinge, or for attaching other door furniture such as hooks.

Preferably the metal plugs 66, metal inserts 76 and extrusion inserts 77 are metal, for example, aluminium.

Whilst the above embodiments disclose various means for facilitating attachment of the door to a hinge engaging the inner peripheral edge of the door, they are not essential and may be omitted if the structural foam layers have sufficient pull-out strength to retain screws (or other attachment means) when the door is hung. Moreover where such means (46, 47; 56, 66, 76) are present each, or one or more of each (e.g. foam insert 56 and metal inserts 76), may be provided with any of the doors 10, 20, 30 of FIGS. 1 to 3.

Referring now to FIG. 8 there is shown a door 80 according to the invention, upon which door furniture has been mounted, for example, hinges 81, a letter box 82, a window 83, and a mortice lock 84. The door furniture 81-84 described above may be fitted to door 80 within compartments cut out of door 80 by machining using a router or other types of cutting equipment. Advantageously, the layers of all embodiments of the door 80 described above can be cut into quickly and cleanly at differing depths to remove the desired amount of material or number of layers. This type of machining affords sites on the door 80 for affixing door furniture such as hinges 81 and lock 84, in addition to handles, hooks, and signs. The lock 84 may be a mortice lock, however, a multipoint lock may also be deployed. Additionally, vacant spaces in door 80 can be made by machining, by removing all layers including outer fascias, core layers, and structural foam layers, which can be used as a letter box 82 or for glazing 83.

Referring now to FIG. 9 there is shown a cross sectional view 83A of the glazing 83 fitted within a door 80 according to FIG. 8. The glazing 83 comprises the composite panel 91 of door 80 and a glazing unit 93. The glazing unit 93 is sealed into the composite panel 91 with glazing profile 94 and sealant 95. The glazing profile 94 is secured to the composite panel 91 with the screws 92. The composite panel 91 comprises a first outer fascia 96, a first structural foam layer 97, a core layer 98, a second structural foam layer 99 and a second outer fascia 100. The composite panel 91 has been machined to remove an inner rectangular portion, which comprises portions of the first structural foam layer 97, the core layer 98, and the second structural foam layer 99. The glazing unit 93 is fitted to first outer fascia 96 and this is secured into the window 83 with the glazing profile 94 and the sealant 95. This provides an inexpensive and effective method for glazing a door 80.

Referring now to FIG. 10 there is shown an enlarged section of a door 110 similar to the door 80 of FIG. 9 and viewed in the direction of arrow C. The door 110 comprises the following layers, which are secured successively in a sandwich structure in the following order: (i) first outer fascia 111; (ii) first structural foam layer 112; (iii) core layer 113; (iv) second structural foam layer 114; and (v) second outer fascia 115. In this embodiment a, preferably extruded, trim section 116 is secured to the exposed terminal edges of layers 111 to 115 along the inner peripheral edge 117 (and preferably around all of the edges of the panel). The trim section 116 is secured to the door 110 using a plurality of screws 118, which are embedded within the second structural foam layer 114. Advantageously, the trim section 116 contains a Eurogroove 119, which provides a reinforced attachment means for the door 110 to be hung by means of hinges to a door frame (not shown).

Additionally, the trim section 116 provides a thermal break 120 between the door 110 and the door frame (not shown), which reduces the flow of thermal energy between the door 110 and the door frame (not shown) to provide thermal insulation.

The trim section 116 also provides an additional securement means for the first outer fascia 111 and the second outer fascia 115 to the first structural foam layer 112 and the second structural foam layer 114 respectively, should the door 110 become damaged and the layers 111 to 115 become unsecured from one another.

FIG. 11 shows a plan view of a portion of a door according to the invention, wherein the first fascia 3 has been cold rolled (pre or post formation of the door) to generate a tounge-and-groove effect. Moreover the external fascia 3 has been treated (pre or post formation of the door) to provide a wood-effect finish. Other finishes and shaping can be used to suit.

FIG. 12 shows an enlarged view of a further embodiment of a door 120 according to FIG. 8, a portion in the direction of arrow C being shown. The door 120 comprises the following components: (i) first outer fascia 121; (ii) structural foam layer 122; (iii) second outer fascia 123; and extruded trim and core layer section 124. In this embodiment, the extruded trim and core layer section 124 is formed as one integral member comprising a trim section 124A, a first core layer section 124B, and a second core layer section 124C. The extruded trim and core layer section 124 may be secured to the door 120 by means of screws 125, adhesives (not shown) or other securement means. The core layer section 124B need not extend across the entire width of the door 120 and may terminate at a point in the middle of the structural foam layer 122. Additionally, there may only be one core layer section 124B provided as part of the extruded trim and core layer section 124. A plurality of core layer sections similar to 124B and 124C may also be provided as part of the extruded trim and core layer section 124, which may extend part of the width, or the full width of the door 120.

Advantageously, the extruded trim and core layer section 124 provides reinforced attachment point for inserting and securing screws 125 within the structure of the door 120, for attachment of the door 120 to a frame with a hinge, or for attaching other door furniture such as hooks.

The structural foam layers described in all embodiments may be polyethylene terephthalate, but may also be polyurethane, or any other suitable polymer capable of being manufactured into a structural foam layer. One example of a suitable structural foam for use as structural foam layers described in any embodiment above is Airex T10 or T92®, available from Airex AG.

Fire retardant structural foam layers described in all embodiments may Airex® T90 but may also be any other structural foam layer comprising a fire-retardant component and suitable for use in a fire door.

Preferably the outer fascias and core layers of all embodiments are metal, and more preferably they are aluminium.

The first and second outer fascias of the composite doors described in the above examples may be protected and aesthetically finished by painting, powder coating or by affixing a cosmetic fascia. Advantageously, this allows the composite doors of the above examples to be used in a variety of different environments and for a variety of different purposes.

The panels formed using the above methods can be converted to doors easily and readily. The manufacturing method provides a robust door which can be cut or trimmed and/or machined to size easily. Also, suitable door furniture or other adornments can be fitted. The panels can be machined to provide peripheral reinforcement, which although is only shown along one edge in the Figured (e.g. FIGS. 4 and 5) may actually extend around two, three or all of the peripheral edges or parts thereof.

The techniques disclosed above can be used to provide door frames 2 (FIG. 1) and window frames by trimming sections to the appropriate dimensions, mitreing and jointing. In particular, fusion bonding can be deployed to join two mitred sections by using an intervening metal sheet. Alternatively, fusion bonding can be deployed to join two sections by welding two sections of foam together. Alternatively, sections can be joined by cleats or by mechanical fixtures. Alternatively, two sections can be welded together externally, for example via the first and second outer fascias, when both of the sections contain the fire retardant structural foam.

Moreover, the techniques disclosed above may also be used to provide a construction material. The composite panel may be used, for example, as (at least part of) roofs, flooring, ceilings and/or external and/or internal walls in building construction. The composite panel may be used as, or as a component of, external cladding for use in building construction and/or insulation. The composite panel may be used as a construction material in the manufacture of aircraft, trains and/or other vehicles.

1. A composite panel comprising a first fascia and a second fascia at least one of which is formed from metal structural sheet material, located between the first and second fascia are a first structural foam layer, a metal core layer and a second structural foam layer, the metal core layer being as thin or thinner than the first fascia and/or as thick or thicker than the second fascia.

2. A composite panel according to claim 1, wherein at least two of the first facia, second fascia and core layer have different thicknesses.

3. A composite panel according to claim 1, wherein the first structural foam layer is thicker, the same thickness or thinner than the second structural foam layer.

4. A composite panel according to claim 1, wherein the density of the first structural foam layer is greater, the same or smaller than that of the second structural foam layer.

5. (canceled)

6. (canceled)

7. A composite panel comprising a composite panel having a first fascia and a second fascia each formed from metal structural sheet material, located between the first and second fascia are a first structural foam layer, a metal core layer and a second structural foam layer, the first structural foam layer being thinner and having a higher density than the second structural foam layer.

8. (canceled)

9. A composite panel according to claim 7, wherein at least two of the first facia, second fascia and core layer have different thicknesses.

10. A composite panel according to claim 1, wherein the first facia and/or the second fascia are formed from aluminium.

11. A composite panel according to claim 1, wherein the metal core layer is formed from aluminium or steel.

12. A composite panel according to claim 1, wherein the metal core is selected from (i) a plain sheet or (ii) a shaped sheet, having local formations across all or a portion of the sheet.

13. A composite panel according to claim 1, wherein the first fascia is from 0.5 to 10 mm thick.

14. A composite panel according to claim 1, wherein the second fascia is from 0.5 to 20 mm thick.

15. (canceled)

16. (canceled)

17. A composite panel according to claim 1, wherein one or both of the structural foam layers is formed from a material selected from polyethylene terephthalate, polyurethane, acrylonitrile-butadiene-styrene (ABS), polystyrene (PS), polycarbonate (PC), polypropylene (PP) or polyvinyl chloride (PVC) and mixtures of the same.

18. A composite panel according to claim 1, wherein one or both of the first structural foam layer or the second structural foam layer comprises inserts for the retention of fixing devices.

19. A composite panel according to claim 1, comprising a first peripheral edge for mounting of hinges.

20. A composite panel according to claim 34, wherein the inserts are located at or towards the peripheral edge.

21. (canceled)

22. A composite panel according to claim 35, wherein the one or more foam inserts extend along the peripheral edge, at least in the region where hinges are required.

23. A composite panel according to claim 22, wherein the one or more foam inserts have a density higher than that of the either or both of the first or second structural foam layers.

24. (canceled)

25. (canceled)

26. (canceled)

27. A method of forming a composite panel, the method comprising the steps of:
a. Heating a first structural sheet member and bringing it into intimate contact with a first structural foam layer whereby a first surface of the foam layer is melted to secure the first structural sheet member to the first structural foam layer;
b. Providing a second structural sheet member and bringing that into intimate contact with the first structural foam layer to secure a second surface of the foam layer to the second structural sheet member;
c. Heating a third structural sheet member and bringing it into intimate contact with a second structural foam layer whereby a first surface of the second structural foam layer is melted to secure the third structural sheet member to the second structural foam layer;
d. Securing the second structural sheet member to the second structural foam layer.

28. (canceled)

29. (canceled)

30. (canceled)

31. (canceled)

32. (canceled)

33. (canceled)

34. A composite panel according to claim 19, wherein one or both of the first structural foam layer or the second structural foam layer comprises one or more inserts for the retention of fixing devices.

35. A composite panel according to claim 20, wherein said one or more inserts are one or more foam inserts.
